(19) United States
(12) Patent Application Publication
(10) Pub. No.: US 2015/0197170 A1
(43) Pub. Date: Jul. 16, 2015

(54) VEHICLE CHAIR NECK SUPPORTING DEVICE AND METHOD OF USING THE SAME

(71) Applicant: Andrey OBUKHOV, Lahti (FI)

(72) Inventor: Andrey OBUKHOV, Lahti (FI)

(21) Appl. No.: 14/154,148

(22) Filed: Jan. 13, 2014

(51) Int. Cl. B60N 2/48

(52) U.S. Cl. CPC B60N 2/4882

(57) ABSTRACT

A device for supporting a person's neck in a vehicle seat has an adjustable cushion assembly integrated into the seat to improve the comfort and safety for drivers and passengers. The device includes a several independently adjustable pads with inflatable bladders to support the back and sides of the neck in operational mode. When deactivated the device is hidden in the structure of the seat. The individual neck-support parameters, such as height, volume, size, shape and relative angular position of the pads, can be actively controlled or memorized by a memory unit.

### CROSS REFERENCE AND RELATED APPLICATIONS

This application claims priority to Russian Utility Model application No. 2013102430 filed Jan. 11, 2013, now Russian Patent No. 132761.

### FIELD OF INVENTION

This invention relates broadly to the device for supporting a person's neck in a vehicle seat by using an adjustable cushion assembly integrated into the seat structure. The invention relates to the field of transport and is designed to improve the comfort and safety of drivers and passengers.

More specifically, the invention discloses an air-pressure adjustable neck support assembly and means of its control and adjustments.

### BACKGROUND OF THE INVENTION

The number of people traveling with a typical traveling time of a few hours constantly growing. Consequently, transporters and vehicle manufacturers have to pay a lot of attention to passenger comfort. This is relevant for all modes of transport—road, rail and air.

Accordingly, vehicle seats, such as commercial airline seats, trains, buses and cars are often occupied by drivers and passengers for extended periods of time. Although many transport seats have adjustment and reclining means, existing seating typically prevents effective and sufficient individual adjustment(s) for comfortable position for a long time. In particular, the available options to accommodate the passenger seat for comfortable sleeping are limited.

Various types of headrests and neck-support units for use in different types of vehicles have been reported. As the general rule, these headrests should ensure adherence to the neck back and sides of the passenger, designed primarily to satisfy safety aspects and provide a comfortable seating posture. Currently, the production of various types of access are used to support the body and head of drivers and passengers. There are seats with lateral support lower and upper torso, as well as various types of restraints, including active head-restraints which provide increased protection of spine in case of accidents. Moreover the different adjustable cushions designed for comfortable lumbar support have also been reported.

Typically, the prior art vehicle headrests comprise a vertically adjustable head support structure, mostly designed to provide protection against injury in the event of an accident. These types of headrests are of a more complicated design and some include greater adjustability features.

Various vehicle headrests provided with lateral headrest pads have also been reported. Many of such headrests are designed for military and commercial aircraft providing personal comfort and, typically, include pivotally movable back and lateral supports. In headrests with lateral supports, the head support elements are typically mounted and slide on spaced apart rods that extend upward from the back of the seat and rely on friction to maintain the headrest in an elevated position. Even more complex headrests have been designed for use in military aircraft conjunction with ejection seats.

Many passengers use a special neck pillow to support their head while trying to sleep in an upright position. The personal neck pillow, being carried by passenger is also not a very successful option due to the natural tendency of a sleeping person to relax the neck muscles and fall towards more horizontal position, thus awakening the passenger. Moreover, while the inflatable pillows take up less room during transport, their require inflation and deflation at the beginning and end of use, respectively. The disadvantages of all mentioned existing systems are that the head of the passenger, especially in a sleeping state leans towards a one side, resulting in an increased tension at the neck area causing discomfort and pain. Another significant disadvantage of existing inflatable neck-supporting pillows is the need to inflate and deflate them before and after using, respectively. Non-inflatable neck-supporting pillows are filled with soft material and take up space in personal luggage, limiting their use by a general public.

Various prior art devices have also been disclosed for constraining the head of a passenger to a seat head rest. In a more sophisticated embodiment, a removable device for neck support used by athletes participating in rally racing, as in the case of an accident provides reliable protection of the cervical spine.

It is desirable to provide an integrated system within or attachable to vehicle transport seats for upright support of a seated passenger in a comfortable position for sleep. Using a relatively low-cost properly designed neck support system by passenger seats would enable manufacturers to significantly increase the level of comfort for the general public, essentially, make the each trip less tiresome.

### SUMMARY OF THE INVENTION

Disclosed a (vehicle) seat headrest assembly, which includes an inflatable neck-support body integrated into a seat. The neck-support unit itself based on a pad that supports the back of the neck and at least two lateral pads that support sides of the neck. Such pads are made of a soft expandable material and include an inflatable bladder of impervious material inside. In particular configuration, all the pads are combined in a single pad with a single (shared) inflatable bladder.

The inflatable bladders is inflated independently by pressurized gas from a gas source via dedicated pipes. The bladders are made to have two modes of operation: i) a ‘rest mode’ with the bladders deflated and ii) an ‘operational mode’ when at least one bladder is inflated. When the neck-support unit is deflated, the neck-support unit is hidden completely inside a seat back.

A seat headrest assembly includes a control pad with buttons to add and reduce the pressure in each pad. The control pad with its buttons/rotating knobs are integrated into the seat or door of the vehicle and capable of independent adjustment the neck-support unit parameters, such as its height, volume, size, shape and relative angular position of the pads.

The ‘rest mode’ enables the seat to operate without any visible external headrest part being attached to the seat, while the source of the pressurized gas (e.g. a compressor) is integrated into the seat or being located separately from the seat. Such source is be used by a single neck-support or more.

The pads are covered by a soft flexible cover and each bladder in the pad is inflated under a corresponding microprocessor controller providing an individual target pressure for each pad, defined by the headrest parameters from the memory unit.

The lateral pads are provided with at least one electronic component selected from a group of: loudspeakers, noise compensation devices, communication systems, navigation systems, voice controlled input interfaces. Moreover, at least one sensor is arranged to recognize the head position relative to a height of the headrest assembly, and adjust at least one of the headrest parameters automatically.

### BRIEF DESCRIPTION OF THE DRAWINGS

Other features and advantages of the invention will become more apparent upon reviewing the appended claims and the following non-restrictive description of embodiments of the invention, given by way of example only with reference to the following drawing:

FIG. 1 shows the front (a) and top (b) views of the chair with integrated adjustable neck-support unit.

FIG. 2—The general view of the passenger in the chair with integrated neck-support unit. The activated mode and deactivated mode of operation is shown, figures a, b, respectively.

FIG. 3—The general view of the passenger in the chair with the integrated neck supporting device.

### DETAILED DESCRIPTION OF THE INVENTION

The proposed invention introduces an adjustable headrest structure, consisting of several independent neck-supporting elements such as pads that can fit over the neck of a person (a seat occupant), providing a lateral support for the neck during a sleep. Such adjustable pads can be filled with air and covered by a soft flexible material.

The disclosed headrest structure includes the neck-support unit which is formed by a several neck-supporting elements (i.e. pads) integrated into a vehicle seat. At least three such independently expandable (back and lateral) neck supporting pads can be switched between active and rest positions using an inflating mechanism.

Moreover, the vertical position of the neck-support unit (with pads included) can be adjusted using a moving mechanism.

Each expandable headrest pads incorporates an inflatable bladder (made of impervious material) to be used by the said inflating mechanism.

In order to satisfy multifunctional headrest requirements, support the unobtrusive freedom of vision and comply with safety standards, the said neck-support unit in the deactivated (storage) position is completely integrated (hidden) in the headrest structure surface contour and can be inflated or moved out of the headrest body contour by a inflating or moving mechanisms.

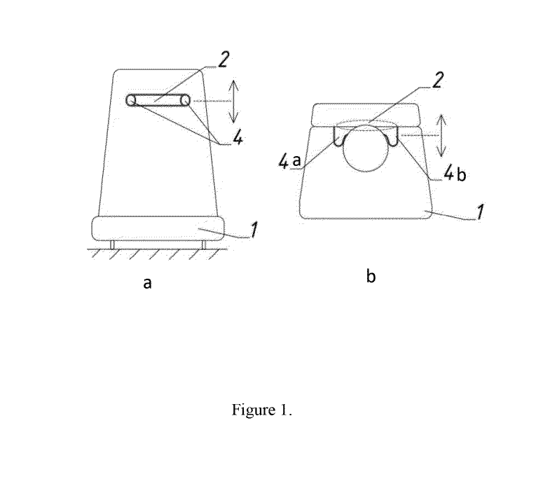

A proposed headrest structure is shown in FIG. 1 by a front (FIG. 1a) and upper view (FIG. 1b). It includes a center pad 2 and two side pads 4a and 4b that are laterally complement the center pad 2. The pads 2, 4a and 4b can be operate independently, namely the shape and size of each pad can be adjusted separately.

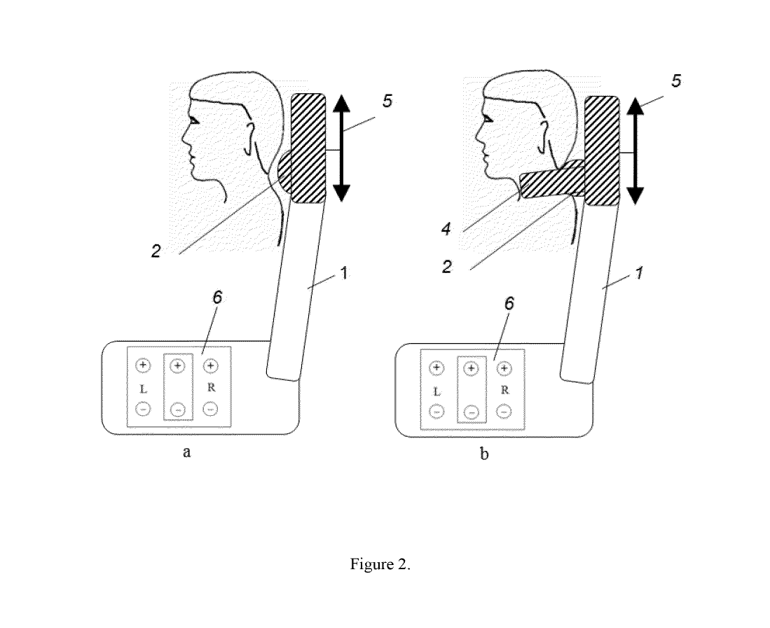

The FIG. 2 shows the operation of the disclosure in more detail. Each pad 2, and pads 4 include an inflatable bladder that is expendable forward (from a seat back 1) into a resting (sleep) position (activated mode, FIG. 2b) and back into a supporting position (deactivated mode, FIG. 2b). The pads made of (and covered by) a soft flexible material ensuring the proper adherence to human neck back and sides and can be adjusted vertically, as shown by arrows 5 in FIG. 2.

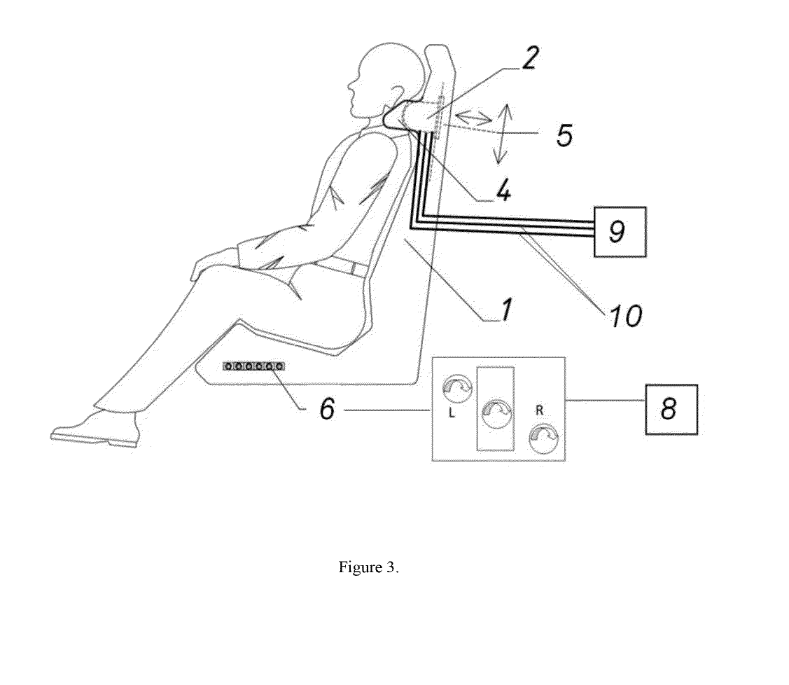

The general view of the chair and the occupant (passenger) with the integrated adjustable neck-support unit is shown in the FIG. 3. The adjustable, inflatable pads 2, 4 are integrated inside the chair 1, along with the height-adjusting mechanism 5.

For the activation/deactivation purpose a fast actuation mechanism is provided, in the form of a set of the expandable bladders that are integrated into the expandable pads 2, 4a and 4b (see FIG. 1) and supplied with pressurized gas from a source 9 (i.e. inflating compressors) either integrated in a seat, combination of seats (e.g. bench) or separated from the seat construction (central-compressor inflatable).

In the preferred embodiment of the invention, the each adjustable pads 2,4 of the headrest structure includes an expandable container (bladder) which operates independently by an air supply 10, each being specifically dedicated to the respective bladder.

Thus, in an activated position (FIG. 2b), the adjustable neck support pads 2,4 can be transformed into an individually-adjustable U-shaped collar comprising of a set of inflatable bladders 2,4 (FIG. 2 and FIG. 3) and a soft flexible cover that provides a wide range of adjusting and styling choices.

When the bladders are inflated simultaneously, the headrest structure expands urging the back pad 2 forward, and simultaneously expanding lateral pads 4 to enlarge the overall width of the headrest structure.

When not in use (pre-deployment configuration, FIG. 2a), the set of inflatable bladders is deflated and the respective pads 2,4 are substantially contained within the structure of the chair 1 (FIG. 2 and FIG. 3), having a typical shape and performance of the conventional headrest support within the chair structure.

The inflatable set of neck support pads 2,4 with bladders forms a headrest structure that is attached to a seat back using a sliding means 5 (e.g. pinch and roller, electrical motor, FIG. 2 and FIG. 3) so that it is easily adjusted by the seat occupant to meet the comfort needs (height, shape and angles).

Furthermore, in the preferred embodiment of the invention the sliding means 5 are included a rail which is integrated within the seat and supports the movement of adjustable headrest pads, thus providing the adjustment of the headrest structure at the height desirable by the passenger.

The actuation mechanism can efficiently expand and adjust the independent headrest pads from their normal (not expanded) state (within the contour of the seat) to the expanded, operational state. This mechanism permits moving the head support pads from the stored (stowed) position into the operational position either by operator (passenger) or automatically, using pre-defined, electronically memorized (individual) settings. With the reference to the FIG. 3, the pressurized gas source 9 has communicating means 10 (pipes) with bladders within each adjustable pad 2, 4 of the neck-support body. It is possible to provide a intermediate (buffer) reservoir that is disposed between the source and the container to smooth the initial pressure surge of the compressed gas source.

In the preferred embodiment of the invention, the actuation mechanism includes the headrest controllable means 6, as shown in FIG. 2 and FIG. 3, for controlling the parameters of the head rest pads, such as their volume, vertical, horizontal and angular (relative) positions. The controlling means (a control pad) are integrated into the seat structure in form of the push-buttons or rotating knobs 6, see FIG. 2 and FIG. 3, respectively.

In another embodiment of the invention, the controlling means are integrated into the door of the vehicle, such as a car.

As the result, the proposed headrest solution enables the seat occupant (passenger) to control the volume, shape (i.e. individual pads' sizes and relative angles) as well height position of the neck-support unit.

The proposed headrest arrangement represents a substantial improvement over the prior art headrests and provide significantly greater adjustability and therefore greater support and comfort to the user. To ensure a comfortable and safe passenger experience, the proposed adjustable device to support a person's neck is integrated directly into the design of the chair. Consequently, when the headrest stricture is deactivated position (headrest bladders are deflated), the seat looks and performs as a regular passenger seat, without visible external headrest element being attached to the chair.

Furthermore, in the preferred embodiment of the invention, the headrest control pad (buttons 6, FIG. 2 and FIG. 3) are used to adjust and electronically memorize the said (e.g. optimal) parameters for each element of the headrest structure by a passenger. Thus, in a preferred configuration, a memory unit 8 (memory block, FIG. 3) is included into the proposed device to memorize the parameters of the headrest pads′, such as their vertical, horizontal and angular positions, which are preferably pre-defined for each individual passenger. The memory unit 8 has dedicated buttons to record and access the said recorded parameters for at least two occupants of the seat.

Furthermore, in a preferred configuration, the set of bladders are inflated under microprocessor control and an individual target pressure values for the bladders are stored in the memory unit. The bladder pressures are monitored by pressure transducers, and the measured pressures are compared with the target (individually pre-defined) pressures. The air under pressure is supplied to each bladder independently, until the comparison indicates that the target pressure has been reached.

In another embodiment of the invention, the headrest assembly includes the lateral pads with at least one electronic component selected from the group consisting of: loudspeakers, noise compensation device, communication system, navigation system, voice controlled input interface, integrated within at least one of the lateral pads.

In yet another embodiment of the invention, at least one optical or mechanical sensor is arranged in the seat headrest assembly to recognize the head position relative to a height of the headrest assembly. Such sensor can adjust at least one of the headrest parameters automatically.

Although several exemplary embodiments have been herein shown and described, those of skill in the art will recognize that many modifications and variations are possible without departing from the spirit and scope of the invention, and it is intended to measure the invention only by the appended claims.

We claim:

1. A seat headrest assembly for an occupant of a vehicle seat, comprising:
an inflatable neck-support unit integrated into a seat; the neck-support unit being completely hidden inside a seat back, when the neck-support unit is deflated; a front surface of the seat back with the deflated neck-support unit has a shape of a front surface of a seat back without the headrest assembly;
the neck-support unit comprising a back pad and at least two lateral pads; the pads being made of a soft expandable material, each said pad comprising an inflatable bladder of impervious material;
the inflatable bladders being inflated independently by pressurized gas from a gas source via at least three pipes, the bladders having two modes of operation: 1) a ‘rest mode’ with the bladders deflated and 2) an ‘operational mode’ when at least one bladder is inflated;
at least three buttons to add pressure and at least three buttons to reduce pressure in each pad, the buttons located in a control pad.

2. The headrest assembly of claim 1, wherein the rest mode enables the seat to operate without any visible external headrest part being attached to the seat.

3. The headrest assembly of claim 1, wherein the source of the pressurized gas is integrated into the seat.

4. The headrest assembly of claim 3, wherein the source is a single source of the pressurized gas being used for the neck-support unit in more than one seat.

5. The headrest assembly of claim 1, wherein the source of the pressurized aas is located separately from the seat.

6. The headrest assembly of claim 1, wherein the source of the pressurized gas is a compressor.

7. The headrest assembly of claim 1, wherein the neck-support unit is attached to the seat by a sliding mechanism, the sliding mechanism having an electrical motor, a rail and a pinch and roller assembly; the sliding mechanism providing a height adjustment for the neck-support unit.

8. The headrest assembly of claim 7, having a positioning sensor to discover a position of the neck relatively to shoulders of the occupant of the vehicle seat.

9. The headrest assembly of claim 8, where the positioning sensor includes an optical sensor or a pressure sensor.

10. The headrest assembly of claim 9, where the positioning sensor is used to move the neck-support unit in vertical direction accordingly to the height adjustment required by a position of the neck relatively to shoulders of the occupant of the vehicle seat.

11. The headrest assembly of claim 1, having the control pad integrated a car door.

12. The headrest assembly of claim 11, wherein the control pad includes the neck-support unit controlling means to control and adjust neck-support unit parameters, the parameters including neck-support unit height, volume, size, shape and relative angular position of the pads.

13. The headrest assembly of claim 12, wherein the neck-support unit parameters can all be controlled independently.

14. The headrest assembly of claim 12, wherein control buttons to control and adjust the neck-support unit parameters are rotating knobs.

15. The headrest assembly of claim 9, further comprising memory buttons connected to a headrest memory unit being used to store the neck-support unit parameters for at least two occupants of the seat; and the buttons extracting the neck-support unit parameters from the memory unit, the neck-support unit parameters being specific to the each occupant.

16. The headrest assembly of claim 1, wherein the back pads, and the lateral pads are combined in a single pad, the single pad having a single inflatable bladder.

17. The headrest assembly of claim 1, where the pads are covered by a soft flexible cover.

18. The headrest assembly of claim 1, where each bladder is inflated under a corresponding microprocessor controller providing an individual target pressure for each pad, the target pressure being defined by the headrest parameters from the memory unit.

19. The headrest assembly of claim 1, wherein the lateral pads are provided with at least one electronic component selected from a group consisting of: loudspeakers, noise compensation devices, communication systems, navigation systems, voice controlled input interfaces.

20. The headrest assembly of claim 1, wherein at least one sensor is arranged in the seat headrest assembly, the sensor to recognize the head position relative to a height of the headrest assembly, the sensor adjusting at least one of the headrest parameters automatically.
